(19) United States
(12) Patent Application Publication
(10) Pub. No.: US 2007/0207241 A1
(43) Pub. Date: Sep. 6, 2007

(54) Combination And Method For The Preparation Of A Drink

(75) Inventor: Reinder Pier Prins, De Lier (NL)

Correspondence Address: YOUNG & THOMPSON, 745 SOUTH 23RD STREET, 2ND FLOOR, ARLINGTON, VA, 22202, US

(73) Assignee: CORSA BEHEER B.V., Bz De Lier (NL)

(21) Appl. No.: 11/663,278

(22) PCT Filed: Sep. 20, 2004
(86) PCT No.: PCT/NL04/00651

§ 371 Date: Mar. 20, 2007

(51) Int. Cl. A23B 7/148

(52) U.S. Cl. 426/106

(57) ABSTRACT

Combination consisting of a container (1) as well as a drink concentrate placed therein. The container can be opened easily without tools and the quantity of drink concentrate precisely corresponds to a single portion. In this way the user can prepare his or her own drink, for example by combination with water. Examples of a drink concentrate are coffee syrup, juice concentrate and the like, optionally combined with alcohol. All that is needed for the preparation of the drink concerned is to add the concentrate to the solvent, such as water, and to stir if necessary. This water can optionally be pre-heated.

The present invention relates to a combination comprising a container as well as a liquid drink concentrate placed therein. Such a combination is known in the state of the art and contains a fairly large quantity of drink concentrate that is suitable for a large number of drinks. The drink concentrate is coffee syrup that is introduced into a coffee machine from the container and that is used for subsequent further treatment and mixing with water in the coffee machine. A large number of cups of coffee can be prepared in such a way.

Nowadays consumers are increasingly demanding individualised products. A known example is found in the case of tea, where it is now customary that the consumer receives a cup of hot water and is offered an assortment box from which he or she can choose a desired teabag.

Such simple possibilities for choice do not exist for other drinks. This means that, for example in the cases of juices, it is necessary to store various types of fully prepared juices, with all the associated disadvantages.

The aim of the present invention is to remove this disadvantage and, on the one hand, to be able to offer the consumer a greater variety of products and, on the other hand, to keep the logistics required for this simple.

This aim is realised with a combination comprising a container and a liquid drink concentrate placed therein, wherein said container is liquid-tight and comprises a container part with a lid part fitted liquid-tight thereon, wherein said lid part is designed to be able to be removed by hand without aids and wherein the quantity of drink concentrate in said container part corresponds to the quantity required for one drink portion.

According to the present invention “consumer packs” are provided that are suitable for one drink only and that can clearly be consumed, preferably by mixing with a solvent. Preferably said solvent is water. The user receives the drink concentrate in a pack that is easy to open and contains a quantity that is precisely sufficient for a single drink. He or she removes the lid in a simple manner without making use of tools and can just pour the quantity of drink concentrate into a drinking beaker or the like in which the solvent, such as water, has been placed previously, or is placed subsequently or at the same time. The water can be pre-heated to prepare hot drinks or, on the other hand, can be cooled to prepare cooled drinks. The quantity of drink concentrate can be relatively small. A volume of 2-15 ml is mentioned as an example. Such a quantity fits, for example, packages for evaporated milk that are currently on the market. However, such evaporated milk packages are not suitable for providing a drink in combination with water. Coffee is still needed for this. Moreover, it is not the milk but the coffee that is the main constituent of the drink and the milk desired can be added to the coffee so as to adjust the taste according to the needs of the individual. With the present invention in principle it suffices only to add water in order to prepare the desired drink in combination with the drink concentrate.

The pack can comprise any pack known in the art that is suitable for keeping a portion of drink concentrate without deterioration.

Coffee syrup is intended as an example of a drink concentrate. This coffee syrup must be differentiated from coffee syrup that is used in vending machines and is subjected to a further treatment in the vending machine. The coffee syrup used according to the invention is suitable for providing a drinkable coffee product immediately in combination with hot water. It is possible to provide different types of coffee syrup with different taste nuances in a simple manner. These can be offered to the users. For instance, it is possible to provide packages containing various types of coffee syrup, as a result of which (different) users can choose a different drink. The various packs can optionally be accommodated in an assortment box.

The drink concentrate can also comprise a juice concentrate. Moreover, alcohol can optionally be added.

The invention will be explained in more detail below with reference to an illustrative embodiment shown in the drawing. In the drawing:

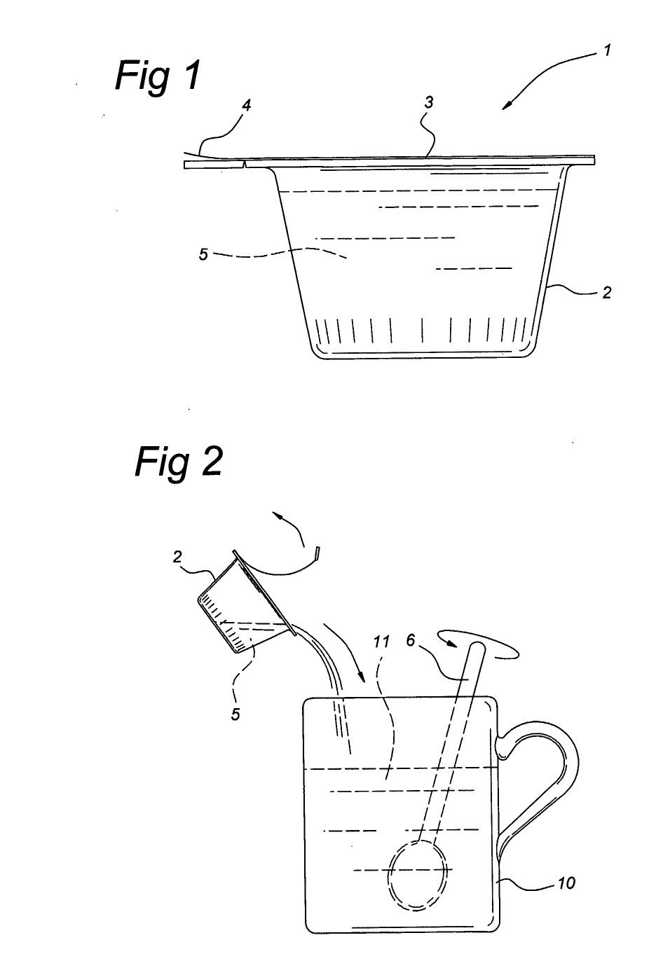

FIG. 1 shows, diagrammatically, the combination according to the invention in the filled state;

FIG. 2 shows the preparation of a drink according to the invention; and

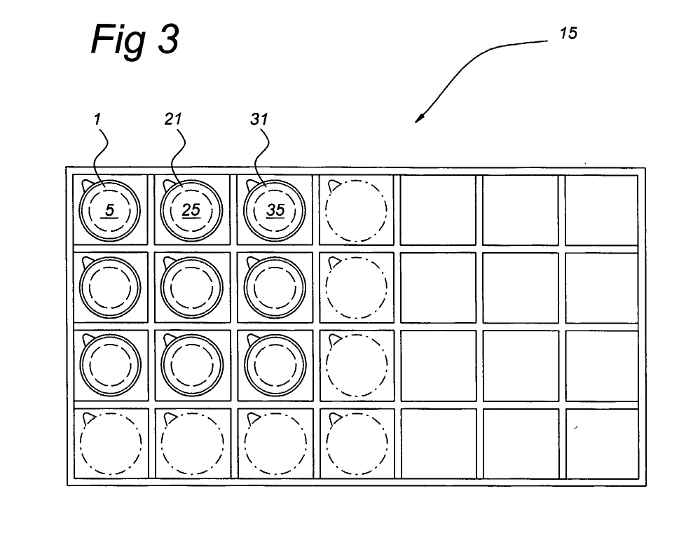

FIG. 3 shows an assortment box according to the present invention.

The combination according to the invention is shown in FIG. 1. This consists of a container 1 made up of a container part 2 provided with a lid 3 with lip 4. The lid 3 can be removed from the top rim of the container part 2 by exerting a pull on the lip 4. In the container 1 the contents thereof are indicated by 5. In this present case these contents consist of a coffee syrup, but it will be understood from the above that other drink concentrates can also be placed therein.

The preparation of a drink is shown diagrammatically in FIG. 2. First, a cup or beaker 10 is provided which is filled with heated water 11. Coffee syrup 5 is then introduced into the hot water while stirring with spoon 6 and mixed therewith. It is, of course, possible to introduce water and coffee syrup together at the same time or to introduce water subsequently into drink container 10.

Optionally, an agent such as milk or sugar that adjusts the taste can then be added to the coffee thus obtained, which agent, however, is not the main constituent of the drink.

A pack, such as an assortment box that is not shown in more detail, is indicated by 15 in FIG. 3. A number of combinations according to the invention, indicated by 1, 21 and 31, have been placed in this pack. The contents thereof are indicated by 5, 25 and 35. The contents always differ from one another, that is to say the packages 1, 21, 31 are identical, apart from the information, and the contents 5, 25, 35 are always different. In this way the user can choose a specific type of drink as desired. These can be various types of coffee or various types of juice.

Although the invention has been described above with reference to a preferred embodiment, it will be understood that numerous modifications can be made thereto without going beyond the scope of the appended claims. For instance, it is possible to modify the packs depending on the contents.

1. Combination comprising a container (1) and a liquid drink concentrate placed therein, wherein said container is liquid-tight and comprises a container part (2) with a lid part (3) fitted liquid-tight thereon, wherein said lid part is designed to be able to be removed by hand without aids and wherein the quantity of drink concentrate (5) in said container part (2) corresponds to the quantity required for one drink only.

2. Combination according to claim 1, wherein said lid (3) is fitted such that it can be torn off said container part (2).

3. Combination according to claim 1, wherein said container part comprises a blow moulded plastic part.

4. Combination according to claim 1, wherein 2-15 cc concentrate is arranged in said container.

5. Combination according to claim 1, wherein said drink concentrate has been treated so as to provide said drink on dilution with water only.

6. Combination according to claim 1, wherein said drink concentrate comprises coffee syrup.

7. Combination according to claim 1, wherein said drink concentrate comprises a juice concentrate.

8. Combination according to claim 1, wherein said drink concentrate contains alcohol.

9. Method for the preparation of a single drink, comprising the provision of a beaker, cup or other drink container and placing a relatively large quantity of water and the contents of the combination according to one of the preceding claims therein.

10. Method according to claim 9, wherein said water is heated.

11. Method according to claim 9, wherein said mixture is stirred after concentrate and water have been added together.

12. Pack (15) containing a number of combinations according to claim 1 (1, 21, 31), wherein the contents of one combination (5) differs from the contents of said other combinations (25, 35).

13. Pack according to claim 12, wherein said pack comprises an assortment box.
